(19) United States
(12) Patent Application Publication
(10) Pub. No.: US 2026/0088865 A1
(43) Pub. Date: Mar. 26, 2026

(54) METHOD AND APPARATUS FOR PRECODER GENERATION

(71) Applicant: Telefonaktiebolaget LM Ericsson (publ), Stockholm (SE)

(72) Inventors: Wei ZHOU, Beijing (CN); Zhao WANG, Täby (SE); Lin YAO, Beijing (CN); Yipeng ZHANG, Beijing (CN)

(73) Assignee: Telefonaktiebolaget LM Ericsson (publ), Stockholm (SE)

(21) Appl. No.: 19/111,684

(22) PCT Filed: Sep. 23, 2022
(86) PCT No.: PCT/CN2022/120851

§ 371 Date: Mar. 13, 2025

(51) Int. Cl. H04B 7/0456; H04L 5/00; H04L 25/02

(52) U.S. Cl. CPC H04B 7/0456; H04L 5/0051; H04L 25/0204

(57) ABSTRACT

Various embodiments of the present disclosure provide a method for precoder generation. The method which may be performed by a communication device comprises: estimating slot-based channel temporal auto-correlation according to a set of channel estimates of reference signals. In accordance with an exemplary embodiment, the method further comprises: selecting a precoder for a first slot from a set of precoder candidates according to the slot-based channel temporal auto-correlation. The set of precoder candidates may be calculated by using at least part of the set of the channel estimates of the reference signals.

### FIELD OF THE INVENTION

The present disclosure generally relates to communication networks, and more specifically, to a method and apparatus for precoder generation.

### BACKGROUND

This section introduces aspects that may facilitate a better understanding of the disclosure. Accordingly, the statements of this section are to be read in this light and are not to be understood as admissions about what is in the prior art or what is not in the prior art.

Multiple-input-multiple-output (MIMO) communication is a technique to serve several users simultaneously with the same time and frequency resource in a wireless communication network. This technique, in which a network node such as a base station and/or a terminal device such as a user equipment (UE) may be equipped with multiple antennas, enables spatial diversity when transmitting data in both uplink (UL) and downlink (DL) directions. The obtained spatial diversity may increase the capacity of the network dramatically and offer a more efficient utilization of the frequency spectrum. Moreover, MIMO can reduce the inter-cell and intra-cell interferences which in turn, leads to more frequency re-use. As the electromagnetic spectrum is a rare resource, MIMO is a vital solution for the extension of the capacity of wireless communication systems.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

A key point for effective deployment of the MIMO communication technology is the access to estimate of the channel responses between a network node and users in the associated network cell, which is usually called channel state information (CSI). For a time division duplex (TDD) based system, it may be possible to apply the physical channel property of reciprocity and use the UL sounding and channel estimation to obtain the DL channel estimates as well. However, due to some reasons such as channel variation, sounding reference symbol/signal (SRS) configuration, signal processing delay in baseband, etc., the estimated channel from uplink sounding may be outdated when applied for designing a downlink precoder which is used for downlink data transmission. The inaccurate precoder may degrade resource efficiency and network performance. Therefore, it may be desirable to implement precoder generation in a more efficient way.

Various exemplary embodiments of the present disclosure propose a precoder generation solution to combat channel aging for communication performance enhancement such as beamforming enhancement. In accordance with various exemplary embodiments, the precoder generation mentioned in this disclosure may refer to precoder selection and/or precoder calculation.

According to a first aspect of the present disclosure, there is provided a method performed by a communication device (e.g., a network node or a terminal device, etc.). The method comprises: estimating slot-based channel temporal auto-correlation according to a set of channel estimates of reference signals. In accordance with an exemplary embodiment, the method further comprises: selecting a precoder for a first slot from a set of precoder candidates according to the slot-based channel temporal auto-correlation. The set of precoder candidates is calculated by using at least part of the set of the channel estimates of the reference signals.

In accordance with an exemplary embodiment, estimating the slot-based channel temporal auto-correlation according to the set of the channel estimates of the reference signals may comprise: obtaining reference signal period-based channel temporal auto-correlation according to the set of the channel estimates of the reference signals.

In accordance with an exemplary embodiment, estimating the slot-based channel temporal auto-correlation according to the set of the channel estimates of the reference signals may further comprise: estimating the slot-based channel temporal auto-correlation according to the reference signal period-based channel temporal auto-correlation.

In accordance with an exemplary embodiment, the slot-based channel temporal auto-correlation may be estimated according to interpolation of the reference signal period-based channel temporal auto-correlation.

In accordance with an exemplary embodiment, the reference signal period-based channel temporal auto-correlation may be obtained according to non-coherent combined calculation on the set of the channel estimates of the reference signals.

In accordance with an exemplary embodiment, estimating the slot-based channel temporal auto-correlation according to the set of the channel estimates of the reference signals may comprise: obtaining slot-based channel estimation according to the set of the channel estimates of the reference signals.

In accordance with an exemplary embodiment, estimating the slot-based channel temporal auto-correlation according to the set of the channel estimates of the reference signals may further comprise: estimating the slot-based channel temporal auto-correlation according to the slot-based channel estimation.

In accordance with an exemplary embodiment, the slot-based channel estimation may be obtained according to interpolation of the set of the channel estimates of the reference signals.

In accordance with an exemplary embodiment, the slot-based channel temporal auto-correlation may be estimated according to non-coherent combined calculation on the slot-based channel estimation.

In accordance with an exemplary embodiment, the precoder selected for the first slot from the set of precoder candidates may be a first precoder candidate which is calculated by using a channel estimate of a second slot. According to the slot-based channel temporal auto-correlation, the second slot, among slots in which reference signals are received by the communication device, may have strongest channel temporal correlation with the first slot.

In accordance with an exemplary embodiment, the precoder selected for the first slot from the set of precoder candidates may be a second precoder candidate which is calculated by using a channel estimate of a third slot. Among slots in which reference signals are received by the communication device, the third slot may be a second closest slot to the first slot.

In accordance with an exemplary embodiment, when a time interval between the first slot and a fourth slot is within a predetermined range, the precoder selected for the first slot from the set of precoder candidates may be a precoder candidate associated with the predetermined range. Among slots in which reference signals are received by the communication device, the fourth slot may be a slot closest to the first slot.

In accordance with an exemplary embodiment, the predetermined range may be a first range, and the precoder candidate associated with the predetermined range may be a third precoder candidate which is calculated by using a channel estimate of the fourth slot.

In accordance with an exemplary embodiment, the predetermined range may be a second range, and the precoder candidate associated with the predetermined range may be a fourth precoder candidate which is calculated by using a channel estimate of a fifth slot. Among the slots in which the reference signals are received by the communication device, the fifth slot may be a second closest slot to the first slot.

In accordance with an exemplary embodiment, the predetermined range may be a third range, and the precoder candidate associated with the predetermined range may be a fifth precoder candidate which is calculated by using a channel estimate of a sixth slot. Among the slots in which the reference signals are received by the communication device, the sixth slot may be a third closest slot to the first slot.

In accordance with an exemplary embodiment, the predetermined range may be based at least in part on one or more of: the slot-based channel temporal auto-correlation; throughput related to the slot-based channel temporal auto-correlation; average channel temporal correlation which is calculated according to the slot-based channel temporal auto-correlation; and reference signal channel estimation processing delay.

In accordance with an exemplary embodiment, the calculation of the average channel temporal correlation may be based at least in part on slots to be scheduled for the communication device.

According to a second aspect of the present disclosure, there is provided an apparatus which may be implemented as a communication device. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a communication device. The apparatus may comprise an estimating unit and a selecting unit. In accordance with some exemplary embodiments, the estimating unit may be operable to carry out at least the estimating step of the method according to the first aspect of the present disclosure. The selecting unit may be operable to carry out at least the selecting step of the method according to the first aspect of the present disclosure.

In accordance with various exemplary embodiments, the slot-based channel temporal auto-correlation may be obtained based at least in part on statistical channel information (e.g., historical channel information, etc.) of reference signals (e.g., SRS, etc.). According to the slot-based channel temporal auto-correlation, a communication device may be able to select a proper precoder from several precoder candidates for a target slot in which data transmission may be scheduled for the communication device. In an embodiment, a channel estimate of a slot which has the strongest channel temporal correlation with the target slot, among slots in which reference signals have been received by the communication device, may be used to generate/calculate the precoder selected for the target slot. This can improve the network throughput and enhance resource utilization by increasing precoder gain, without or with less consideration of channel estimation processing delay.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating an exemplary TDD frame structure according to an embodiment of the present disclosure;

FIG. 2 is a diagram illustrating exemplary channel information processing according to an embodiment of the present disclosure;

FIGS. 3A-3F are diagrams illustrating exemplary parameters and performance according to some embodiments of the present disclosure;

FIGS. 4A-4B are diagrams illustrating exemplary precoder generation according to some embodiments of the present disclosure;

FIG. 5 is a flowchart illustrating an exemplary method according to an embodiment of the present disclosure;

FIGS. 6A-6B are block diagrams illustrating various apparatuses according to some embodiments of the present disclosure;

FIG. 7 shows an example of a communication system 700 in accordance with some embodiments;

FIG. 8 is a block diagram of a host 800, which may be an embodiment of the host 716 of FIG. 7, in accordance with various aspects described herein; and

FIG. 9 shows a communication diagram of a host 902 communicating via a network node 904 with a UE 906 over a partially wireless connection in accordance with some embodiments.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g., refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Wireless communication networks are widely deployed to provide various telecommunication services such as voice, video, data, messaging and broadcasts. To meet dramatically increasing network requirements on traffic capacity and data rates, one interesting option for communication technique development is to apply MIMO technology in a wireless communication network to offer a more efficient utilization of radio resources with reduced interferences.

The effective deployment of the MIMO communication technology may be related to accurate estimation of the channel responses between a gNB and UEs served by the gNB. These channel responses may include those in DL and UL transmissions and help to form the beam from the gNB toward the intended UEs. The channel in the UL direction may be usually estimated using pilot symbols (reference signals) sent by the UEs and received by the gNB (often called “sounding” and for example implemented as SRS in 3GPP LTE and/or NR networks).

For a TDD-based system, according to the physical channel property of reciprocity, the UL sounding and channel estimation may be used to obtain the DL channel estimates. The DL channel estimates, consequently, can be used to calculate the weight for the beamforming. In fact, the reciprocity-based algorithms for beamforming in the downlink transmission are amongst the most successfully exploited algorithms in MIMO and are predicted to be widely exploited in the 5G wireless communication networks. This class of algorithms are applicable whenever the so-called channel reciprocity holds. More precisely, it is assumed that the channel frequency response between two antennas in the uplink is the same as the channel frequency response in the downlink multiplied by a constant complex scalar. Using this fact, the estimated channel in the uplink may be used to decide the direction for beamforming in the downlink. This principle holds, when time-division multiplexing is used for sharing data transmission time between the DL and UL transmissions.

Even though it is possible to obtain the CSI based on channel reciprocity from uplink channel estimation, two facts may have great impact of the CSI accuracy: noise and interference on the reference signals which degrades the channel estimation performance, and the mismatch from the uplink measurement with the downlink ground truth channel. The latter aspect may be caused by UE mobility and SRS processing delay.

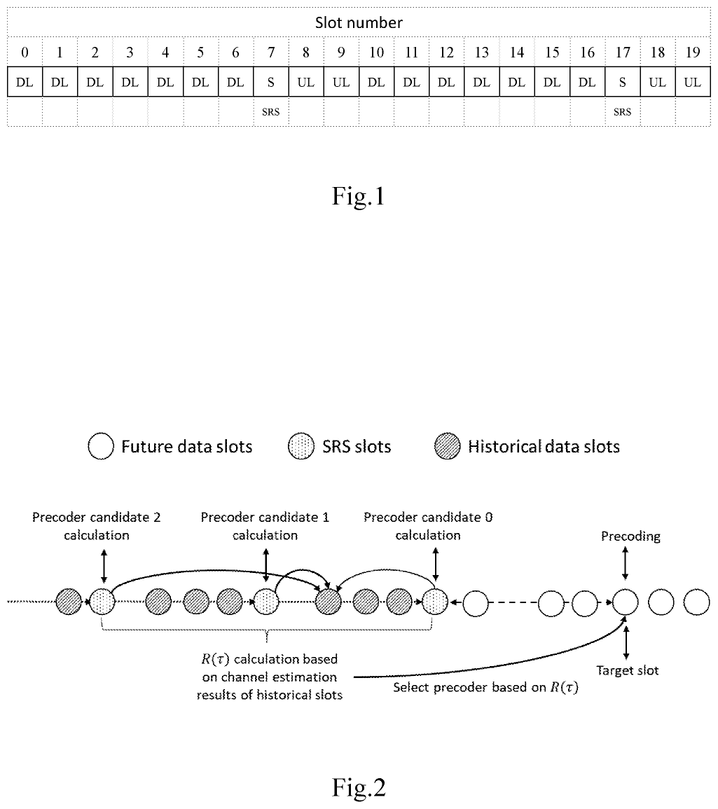

In accordance with some exemplary embodiments, the estimated channel from uplink sounding may be outdated when applied for designing a downlink precoder which is used for downlink data transmission, due to the following reasons:
TDD frame structure
TDD transmission may switch between downlink and uplink transmission in time domain. If it is a downlink heavy TDD configuration, then the estimated channel, based on uplink slot, may be outdated for the following downlink transmission slots.
FIG. 1 is a diagram illustrating an exemplary TDD frame structure according to an embodiment of the present disclosure. In the TDD pattern example shown in FIG. 1, slots 0 to 6 may be used for DL transmission, and slots 7, 8, 9 may be reserved for UL channel estimation (where slot 7 is a specifical slot). The estimated channel may then be outdated for the following slots, indexed by 10 to 16. For fast fading channels, it may be expected that the channels vary significantly from the UL measurement to DL transmission, e.g., because of Doppler, UE mobility, and the changes of propagation environment.
SRS configurations with large SRS transmission periodicity to address the SRS capacity issue
When the number of UEs scheduled to transmit SRS signals is large, it may be quite challenging to allow every UE to transmit an SRS signal during a single UL transmission occasion. The reason behind this is that the SRS transmission capacity of each UL transmission occasion is limited. In other words, to allow more UEs to have SRS transmission opportunities, the network may need to increase the SRS transmission periodicity. As a by-product, for each UE, SRS transmission occasions may be far apart. For example, the SRS transmission periodicity may be configured as 20 ms, even though every 5 ms there may be UL transmission occasion.
SRS processing delay in baseband
Because of the computational limitation, a certain milliseconds of processing delay may exist before obtaining the channel estimation based on the SRS. For example, by receiving the SRS at slot 7, it may be so that DL transmission can utilize the channel estimate after slot 13 due to 6 slots processing delay. The channel may vary during this time duration.
UE in high velocity
The severity of the CSI outdating caused by the abovementioned facts may depend on the UE velocity. If a UE is stationary, then the channel is likely to remain close to constant during a long period of time and the outdating may generally not be an issue. However, when a UE is moving, the CSI experienced by the UE may be changing slot by slot. Then, the outdating issue may become severe, especially when the UE is in high velocity.

In the prevalent radio access technology (RAT) transmission, the UL channel estimation may be directly applied for DL precoder calculation. Due to the velocity increase of UE, the aging of the CSI may degrade the RAT performance. Therefore, it may be desirable to provide a precoder generation solution to combat channel aging, e.g., for beamforming enhancement.

In order to combat channel aging, different methods of channel prediction have been explored in recent years. As an example, the Kalman filter-based channel prediction may be the primary technical focus for beamforming enhancement. The principal idea of channel prediction is to make accurate estimations and provide an accurate precoder for DL transmissions based on the historical channel states to catch up with the fast fading.

However, with the baseband processing delay for channel estimation and prediction, the prediction performance may be limited because the DL transmission slot may be less correlated with the historical channel states estimated from UL. How to further enhance the channel prediction with complexity and real-time processing constraints is still challenging in practice. Hence, existed solutions try to decrease UL channel estimation processing delay as much as possible which leads heavy pressure to implementation.

In fact, even though without baseband processing delay for channel estimation and prediction, the prediction performance may also need improvement especially for the DL slots which are far from a reference signal slot. It can be appreciated that the term “reference signal slot” used herein may refer to a time slot in which a reference signal such as SRS may be transmitted/received.

As a newly aroused issue for the 5G network, how to enhance the massive MIMO performance is still an open research and development problem which may need innovative solutions from one or more of the aspects including channel estimation/prediction, precoding, and scheduling.

Various exemplary embodiments of the present disclosure propose a solution to implement temporal auto-correlation based precoder generation. In accordance with an exemplary embodiment, the term “temporal auto-correlation” used herein may refer to time auto-correlation or time domain auto-correlation, and these terms may be used interchangeably in this document. Similarly, the term “temporal correlation” used herein may refer to time correlation or time domain correlation, and these terms may be used interchangeably in this document.

Contrary to decreasing channel estimation processing delay to increase channel prediction performance, the proposed solution for channel temporal auto-correlation assisted precoder generation may have no requirement for channel estimation processing delay. According to the proposed solution, several precoder candidates may be calculated based on channel estimation of reference signals (e.g., latest several UL reference signals such as SRS). In accordance with an exemplary embodiment, a per slot temporal auto-correlation function, R(τ), may be obtained periodically. The period may depend on calculation capability and operating scenario. In accordance with an exemplary embodiment, the term “per slot” used herein may refer to “slot-based”, and thus the per slot temporal auto-correlation function may also called the slot-based temporal auto-correlation function in this disclosure.

In accordance with an exemplary embodiment, new temporal auto-correlation functions may be generated by left-shifting the per slot temporal auto-correlation function obtained previously with integer times of reference signal transmission period, so as to facilitate comparison of temporal correlation values. The new temporal auto-correlation functions may correspond to different precoder candidates, respectively. The number of the new temporal auto-correlation functions may be configurable.

In accordance with an exemplary embodiment, a time interval between a target slot (e.g., a DL slot, etc.) and the latest slot in which an SRS is received may be calculated and taken as an independent value to get the largest correlation value among different new temporal auto-correlation functions. According to the largest correlation value, a function index may be determined to indicate a precoder candidate which may be picked up for data transmission in the target slot.

FIG. 2 is a diagram illustrating exemplary channel information processing according to an embodiment of the present disclosure. FIG. 2 shows a plurality of slots including historical data slots, SRS slots and future data slots. It can be appreciated that the term “data slot” used herein may refer to a slot in which data may be transmitted/received, and the term “SRS slot” used herein may refer to a slot in which an SRS may be transmitted/received.

In accordance with an exemplary embodiment, DL precoder candidates P(c) may be calculated as below based on UL channel estimation results of several latest SRS slots.

$$P ( c ) = F ( {h}_{c} ) \qquad ( 1 )$$

where F (·) is a precoder calculation function, the input of which is a channel estimate h_{c}, c is an SRS slot index from 0 (latest) to Γ−1 (oldest), and Γ is a configurable parameter which determines the number of precoder candidates. FIG. 2 shows precoder candidates 0, 1, 2, and one of the three precoder candidates may be selected for precoding data transmission in a future data slot.

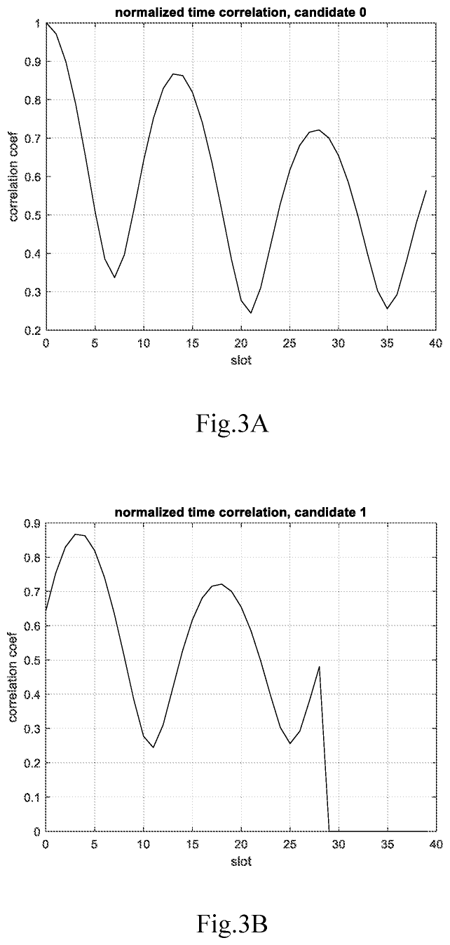

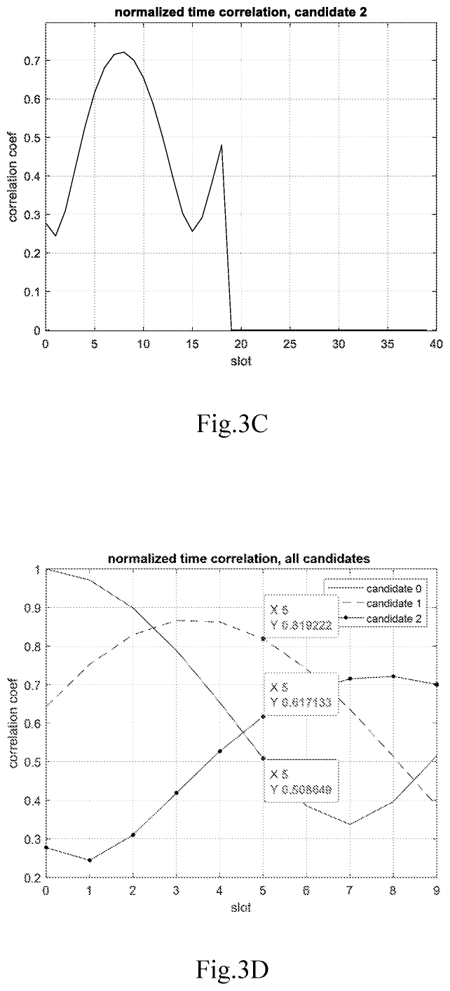

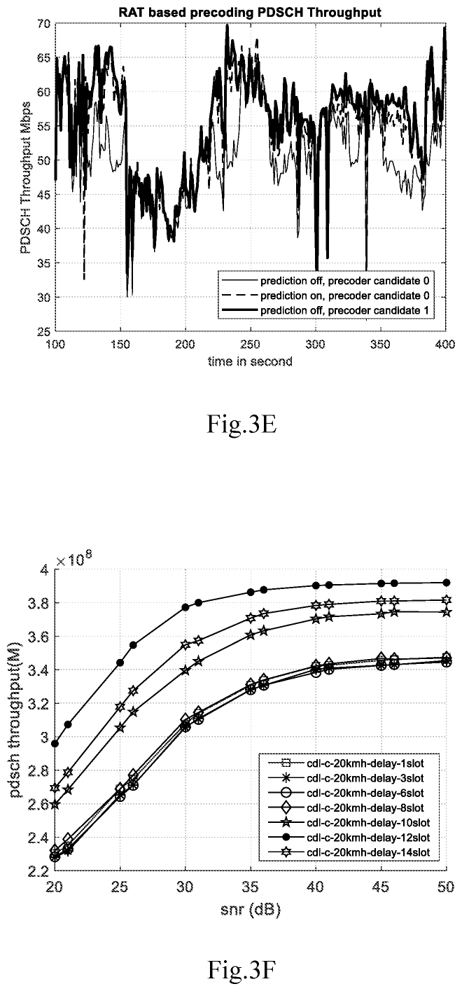

In accordance with an exemplary embodiment, the proposed precoder generation solution may select one optimum precoder among several precoder candidates calculated based on the latest several reference signal (like SRS) slots. The selection basis may be the per slot temporal auto-correlation result. Taking SRS as reference signal for example, the detailed processing procedure may be as below.
Per SRS period time correlation (also called per SRS period time auto-correlation in this disclosure) may be estimated based on several latest SRS slots according to the formula below:

$${R}_{S R S} ( τ ) = \frac{1}{N - τ} {\sum }_{i = 0}^{N - 1 - τ} {h}_{i + τ} \cdot {h}_{i}^{*} , 0 \leq τ < Γ \qquad ( 2 )$$

where R_{SRS}(τ) is a per SRS period temporal correlation function, hᵢ is a channel estimation result of SRS slot i which may be in any domain (e.g., time domain or frequency domain), τ is an independent variable of the temporal correlation function, Γ is a configurable parameter which determines the number of precoder candidates, N is the number of historical SRS channel estimates which may be stored in a buffer, and Nis no smaller than Γ.
Per slot time correlation Rₛₗₒₜ(τ) (also called per slot time auto-correlation in this disclosure) may be estimated based on the per SRS period time auto-correlation R_{SRS}(τ), or based on per slot channel estimation results which may be interpolation of per SRS slot channel estimation results (e.g., hᵢ for SRS slot i).
Optionally, new per slot time auto-correlation results Rₛₗₒₜ(τ, n) may be obtained by left shifting the above per slot time auto-correlation Rₛₗₒₜ(τ) according to the formula below:

$${R}_{slot} ( τ , n ) = \{ \begin{matrix}{R}_{slot} ( τ + nT ) , & τ + nT < Γ T \\ 0 , & otherwise\end{matrix} \qquad ( 3 )$$

where T is the SRS period in slots, n is a precoder candidate index and the range of n is 0˜Γ (where Γ is a configurable parameter which determines the number of precoder candidates).
As an example, FIGS. 3A-3D are diagrams illustrating exemplary correlation coefficients according to exemplary embodiments of the present disclosure. Specifically, FIG. 3A shows the normalized per slot time correlation for precoder candidate 0, FIG. 3B shows the normalized per slot time correlation for precoder candidate 1, FIG. 3C shows the normalized per slot time correlation for precoder candidate 2, and FIG. 3D shows the normalized per slot time correlation for three precoder candidates 0, 1 and 2.
For a target slot (e.g., a DL slot in which precoding is to be performed on data transmission, etc.), the time interval Tal between the target slot and the latest SRS slot the channel estimation of which is ready may be calculated.
A candidate index c may be determined according to the formula below:

$$c = {arg max}_{n} \{ {R}_{slot} ( {τ}_{dl} , n ) \} \qquad ( 4 )$$

A precoder candidate indicated by the index c may be selected as the precoder of the target slot. For example, when the time interval between the target slot and the latest SRS slot the channel estimation of which is ready is τ_{dl}=5, the maximum per slot time correlation coefficient is Rₛₗₒₜ(5, 1), as shown in FIG. 3D. Therefore, the precoder candidate 1 may be selected as the precoder of the target slot.

In accordance with an exemplary embodiment, the time correlation R(τ) (e.g., R_{SRS}(τ), Rₛₗₒₜ(τ), etc.) may be calculated non-coherent combined as below to eliminate the impact of random phase jump.

$$R ( τ ) = \frac{1}{N - τ} {\sum }_{j = 0}^{N - 1 - τ} \vert {h}_{j + τ} \cdot {h}_{j}^{*} \vert \qquad ( 5 )$$

where hⱼ is a channel estimation result of slot j which may be in any domain (e.g., time domain or frequency domain), τ is an independent variable of the temporal correlation function, N is the number of historical channel estimates which may be stored in a buffer.

In accordance with an exemplary embodiment, the precoder selection may be performed from precoder candidates except for precoder candidate 0, if the time interval τ_{dl} dis smaller than SRS channel estimation processing delay. In order to decrease implementation complexity, it may be preferable to always select precoder candidate 1. The reason is due to the SRS channel estimation processing delay, the precoder candidate 0 may be usually low correlated with the target slot, meanwhile, precoder candidate 2 may be usually lower correlated with target slot than precoder candidate 1.

FIG. 3E shows performance comparison of precoder candidates and prediction. As shown in FIG. 3E, using precoder candidate 1 may achieve higher physical downlink shared channel (PDSCH) throughput than using precoder candidate 0. It also can be seen from FIG. 3E that even though channel prediction is turned off, DL throughput increases apparently if precoder candidate 1 is used rather than precoder candidate 0. It is noted that the simulation is performed based on real channel which is traced from over the air (OTA).

In accordance with an exemplary embodiment, when the time interval τ_{dl} is within a predetermined range, a precoder candidate associated with the predetermined range may be selected for the target slot. According to various embodiments, the predetermined range may be determined according to SRS processing delay, or derived from Rₛₗₒₜ(τ) and/or throughput based on Rₛₗₒₜ(τ), etc. As an example, if 0<τ_{dl}<TH₁, where TH₁ is a threshold determined by SRS processing delay, then precoder candidate 1 may be selected for the target slot; otherwise, precoder candidate 0 may be selected for the target slot. As another example, when TH₂≤τ_{dl}<TH₃, where TH₂ and TH₃ are thresholds determined by SRS processing delay and/or throughput calculation, then precoder candidate 0 may be selected for the target slot; otherwise, precoder candidate 1 may be selected for the target slot. FIG. 3F shows performance comparison of delay in terms of PDSCH throughput. As shown in FIG. 3F, the relationship between throughput and channel estimation processing delay is not simply linear, further, large delay may even lead to higher throughput.

In accordance with an exemplary embodiment, the predetermined range may be derived by average correlation calculation. This may be used to handle the case of multi-slot scheduling rather than just single-slot scheduling. For a terminal device, there may be many DL slots after 1 SRS slot. In order to reach higher throughput, it may be the average throughput rather than the peak throughput of one slot that may determine the throughput performance. Meanwhile, the throughput may be dependent to time correlation.

In accordance with an exemplary embodiment, the average time correlation coefficient R_{avg}(s) of each continuous T slots may be calculated based the per slot temporal auto-correlation coefficient Rₛₗₒₜ(τ) according to the formula below:

$${R}_{a v g} ( s ) = \frac{1}{T} {\sum }_{τ = 0}^{T - 1} {R}_{slot} ( τ + s ) , s < m T \qquad ( 6 )$$

where T is the SRS period in slots, m is a configurable parameter which depends on implementation calculation capability (e.g., the recommended value of m may be no greater than 3 considering the balance between implementation calculation capability and performance), s is an index which indicates the start point of the sliding window, and the window length is T.

When the average time correlation coefficient of each continuous T slots is calculated, the maximum average time correlation coefficient may be obtained. In an embodiment, an index s of the maximum average time correlation coefficient may indicate the distance from the latest SRS slot.

$$T {H}_{4} = {arg max}_{S} \{ {R}_{a v g} ( s ) \} \qquad ( 7 )$$

As an example, if TH₄≤τ_{dl}<TH₄+T, where TH₄ is a threshold which may be determined according to formula (7), and T is the sliding window length for average calculation (e.g., T may be the SRS period in slots), then a precoder candidate (e.g., precoder candidate 0 or any other suitable precoder candidates) associated with the range [TH₄, TH₄+T) may be selected for the target slot. It means that from slot TH₄ to slot TH₄+T, if precoder candidate 0 is applied, throughput may be the highest. Then for the slot before slot TH₄, another precoder candidate such as precoder candidate 1 may be applied.

In accordance with an exemplary embodiment, the calculation of R_{avg}(s) may exclude the slots which are not used by the user, especially for the case that the user is not scheduled continuously.

In accordance with an exemplary embodiment, a relation between throughput and time correlation and signal to noise ratio (SNR), e.g., throughput vs. (time correlation & SNR) may be obtained and optionally maintained in a table. Then for a given SNR, a time correlation coefficient may be converted into the throughput. Hence, the relation between slot interval and throughput may be determined, which may be used for precoder selection.

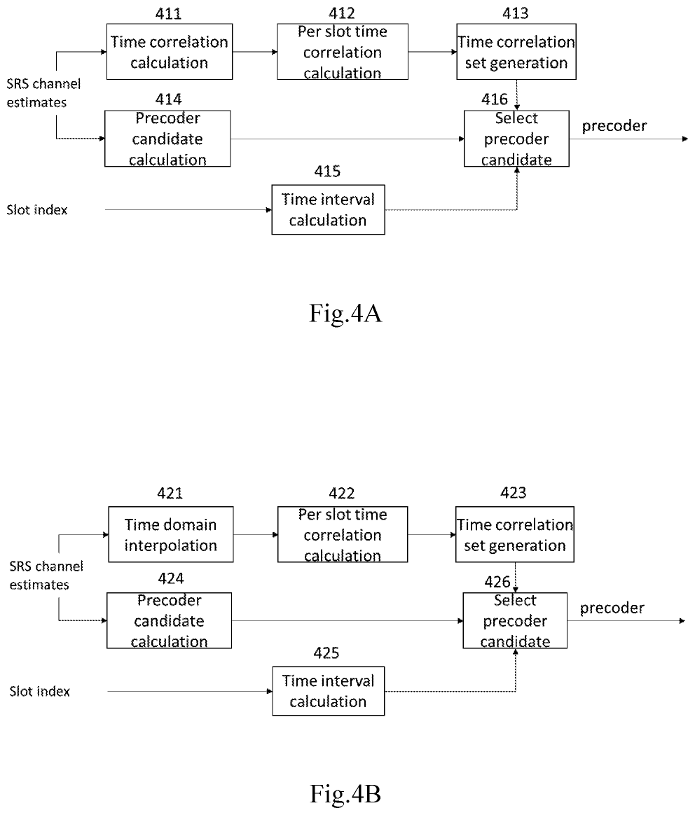

FIGS. 4A-4B are diagrams illustrating exemplary precoder generation according to some embodiments of the present disclosure. The precoder generation may be based on the access of the per slot temporal auto-correlation. There may be usually two schemes as illustrated in FIG. 4A and FIG. 4B to implement the temporal auto-correlation based precoder generation. The difference between the two schemes is how to derive a per slot time correlation function.

According to the scheme shown in FIG. 4A, on the one hand, a time correlation function may be calculated 411 based on historical SRS channel estimates. Hence, the unit of the independent variable of the time correlation function is SRS transmission period. In an embodiment, an interpolation approach may be performed to the previously obtained time correlation function to derive 412 a per slot time correlation function, and the unit of the independent variable of the per slot time correlation function is slot. It can be appreciated that the time correlation calculation in block 411 and 412 may be triggered periodically. Then a time correlation set may be generated 413 based on the per slot time correlation function. On the other hand, several precoders may be calculated 414 based on the historical SRS channel estimates to make a set of precoder candidates. A precoder may be selected 416 among the precoder candidates according to the time correlation set and a time interval 415 between a target slot and the latest SRS slot the channel estimation of which is ready.

According to the scheme shown in FIG. 4B, on the one hand, per slot channel estimates may be obtained by interpolation 421 based on historical SRS channel estimates. Then a per slot time correlation function may be derived 422 according to the per slot channel estimates which may be used to indicate channel estimates of each historical slot. It can be appreciated that the time correlation calculation in block 422 may be triggered periodically. Similar to the scheme shown in FIG. 4A, a time correlation set may be generated 423 based on the per slot time correlation function. On the other hand, several precoders may be calculated 424 based on the historical SRS channel estimates to make a set of precoder candidates. A precoder may be selected 426 among the precoder candidates according to the time correlation set and a time interval 425 between a target slot and the latest SRS slot the channel estimation of which is ready.

It can be appreciated that various exemplary embodiments as described in the present disclosure may be based on a fact that throughput performance may depend on the correlation of precoder and real-time truth channel. When the correlation coefficient increases, the throughput may usually increase, too.

Contrary to conventional cognition, the temporal auto-correlation function is not a monotonically decreasing function of time interval. Instead, the temporal auto-correlation function is often oscillating in time, as shown in FIG. 3A. Based on this property, a precoder may be generated based on historical UL channel estimation so that DL transmission for a certain slot may be always provided with a better precoder which is strong correlated with the UL measurement, subject to the processing delay constraint, to obtain high precoding gain.

Even if the precoder is calculated based on historical channel information, it can still be high correlated with future channel. Hence, the channel temporal auto-correlation may be obtained first and then a precoder of each DL slot may be generated based on historical UL channel estimation accordingly.

Many advantages may be achieved by applying the proposed solution. For example, the proposed solution may improve the cell throughput and increase spectrum efficiency by raising the correlation between precoder and real-time channel which leads to the increase of DL precoder gain. The proposed solution may have no requirement for UL channel estimation processing delay. Thus, it may be feasible to implement. Moreover, according to simulations based on both the 3GPP spatial channel model and the real channel traced from OTA, the proposed solution can provide apparently a huge gain. The proposed solution can even outstand the channel prediction algorithm which has high complexity.

It can be appreciated that although some exemplary embodiments are described with respect to precoder selection of a DL slot, the same principle may be applied to precoder selection of a UL slot. In fact, various exemplary embodiments described in the present disclosure may be applicable without loss of meaning to any communication devices which may need to generate a precoder for data communication in a time slot to be scheduled.

It is noted that some embodiments of the present disclosure are mainly described in relation to 4G/LTE or 5G/NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

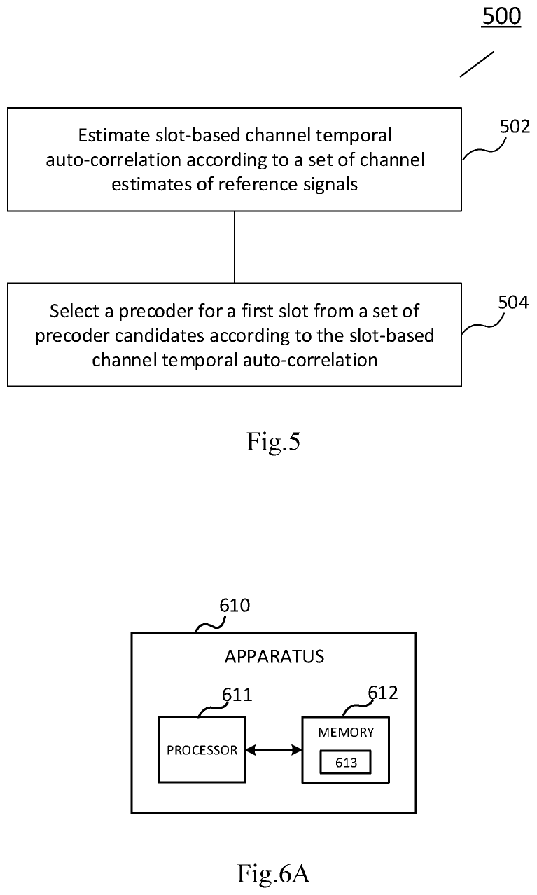

FIG. 5 is a flowchart illustrating a method 500 according to some embodiments of the present disclosure. The method 500 illustrated in FIG. 5 may be performed by a communication device (e.g., a network node, a terminal device, etc.) or an apparatus communicatively coupled to the communication device. In accordance with an exemplary embodiment, the communication device may be configured to perform channel estimation according to reference signals (e.g., SRS, etc.) from other devices.

According to the exemplary method 500 illustrated in FIG. 5, the communication device may estimate slot-based channel temporal auto-correlation (e.g., Rₛₗₒₜ(τ) as described with respect to FIG. 2) according to a set of channel estimates of reference signals (e.g., hᵢ of SRS slot i as described with respect to FIG. 2), as shown in block 502. In accordance with an exemplary embodiment, the communication device may select a precoder for a first slot (e.g., a DL/UL slot in which data transmission is to be scheduled, etc.) from a set of precoder candidates (e.g., precoder candidates 0, 1 and 2 as described with respect to FIG. 2 and FIG. 3D) according to the slot-based channel temporal auto-correlation, as shown in block 504. In an embodiment, the set of precoder candidates may be calculated by using at least part of the set of the channel estimates of the reference signals (e.g., according to formula (1) or any other suitable algorithms).

In accordance with an exemplary embodiment, estimating the slot-based channel temporal auto-correlation according to the set of the channel estimates of the reference signals may comprise: obtaining reference signal period-based channel temporal auto-correlation (e.g., R_{SRS}(τ) as described with respect to FIG. 2) according to the set of the channel estimates of the reference signals (e.g., according to formula (2) or any other suitable algorithms).

In accordance with an exemplary embodiment, the reference signal period-based channel temporal auto-correlation may be obtained according to non-coherent combined calculation on the set of the channel estimates of the reference signals (e.g., according to formula (5) or any other suitable algorithms).

In accordance with an exemplary embodiment, estimating the slot-based channel temporal auto-correlation according to the set of the channel estimates of the reference signals may further comprise: estimating the slot-based channel temporal auto-correlation according to the reference signal period-based channel temporal auto-correlation. In an embodiment, the slot-based channel temporal auto-correlation may be estimated according to interpolation of the reference signal period-based channel temporal auto-correlation.

In accordance with an exemplary embodiment, estimating the slot-based channel temporal auto-correlation according to the set of the channel estimates of the reference signals may comprise: obtaining slot-based channel estimation according to the set of the channel estimates of the reference signals. In an embodiment, the slot-based channel estimation may be obtained according to interpolation of the set of the channel estimates of the reference signals.

In accordance with an exemplary embodiment, estimating the slot-based channel temporal auto-correlation according to the set of the channel estimates of the reference signals may further comprise: estimating the slot-based channel temporal auto-correlation according to the slot-based channel estimation. In an embodiment, the slot-based channel temporal auto-correlation may be estimated according to non-coherent combined calculation on the slot-based channel estimation (e.g., according to formula (5) or any other suitable algorithms).

In accordance with an exemplary embodiment, the precoder selected for the first slot from the set of precoder candidates may be a first precoder candidate (e.g., precoder candidate 0 shown in FIG. 2) which is calculated by using a channel estimate of a second slot. According to the slot-based channel temporal auto-correlation, the second slot, among slots in which reference signals are received by the communication device, may have strongest channel temporal correlation with the first slot.

In accordance with an exemplary embodiment, the precoder selected for the first slot from the set of precoder candidates may be a second precoder candidate (e.g., precoder candidate 1 shown in FIG. 2) which is calculated by using a channel estimate of a third slot. Among slots in which reference signals are received by the communication device, the third slot may be a second closest slot to the first slot.

In accordance with an exemplary embodiment, when a time interval (e.g., τ_{dl} as described with respect to FIG. 2) between the first slot and a fourth slot is within a predetermined range, the precoder selected for the first slot from the set of precoder candidates may be a precoder candidate associated with the predetermined range. Among slots in which reference signals are received by the communication device, the fourth slot may be a slot closest to the first slot.

In accordance with an exemplary embodiment, the predetermined range may be a first range (e.g., a range from 0 slot to 2 slots as shown in FIG. 3D), and the precoder candidate associated with the predetermined range may be a third precoder candidate (e.g., precoder candidate 0 as described with respect to FIG. 2 and FIG. 3D) which is calculated by using a channel estimate of the fourth slot.

In accordance with an exemplary embodiment, the predetermined range may be a second range (e.g., a range from 3 slots to 6 slots as shown in FIG. 3D), and the precoder candidate associated with the predetermined range may be a fourth precoder candidate (e.g., precoder candidate 1 as described with respect to FIG. 2 and FIG. 3D) which is calculated by using a channel estimate of a fifth slot. Among the slots in which the reference signals are received by the communication device, the fifth slot may be a second closest slot to the first slot.

In accordance with an exemplary embodiment, the predetermined range may be a third range (e.g., a range from 7 slots to 9 slots as shown in FIG. 3D), and the precoder candidate associated with the predetermined range may be a fifth precoder candidate (e.g., precoder candidate 2 as described with respect to FIG. 2 and FIG. 3D) which is calculated by using a channel estimate of a sixth slot. Among the slots in which the reference signals are received by the communication device, the sixth slot may be a third closest slot to the first slot.

In accordance with an exemplary embodiment, the predetermined range may be based at least in part on one or more of: the slot-based channel temporal auto-correlation; throughput related to the slot-based channel temporal auto-correlation; average channel temporal correlation (e.g., R_{avg}(s) as described with respect to FIG. 2) which may be calculated according to the slot-based channel temporal auto-correlation (e.g., based on formula (6) or any other suitable algorithms); and reference signal channel estimation processing delay.

In accordance with an exemplary embodiment, the calculation of the average channel temporal correlation may be based at least in part on slots to be scheduled for the communication device.

In accordance with an exemplary embodiment, the communication device may use the selected precoder to perform precoding for data, and transmit the precoded data to another communication device (e.g., a network node or a terminal device, etc.) in the first slot.

The various blocks shown in FIGS. 4A-4B and FIG. 5 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

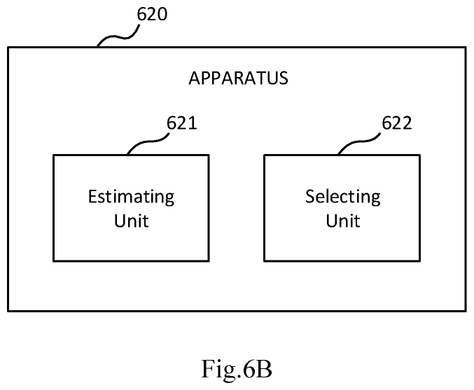

FIG. 6A is a block diagram illustrating an apparatus 610 according to various embodiments of the present disclosure. As shown in FIG. 6A, the apparatus 610 may comprise one or more processors such as processor 611 and one or more memories such as memory 612 storing computer program codes 613. The memory 612 may be non-transitory machine/processor/computer readable storage medium. In accordance with some exemplary embodiments, the apparatus 610 may be implemented as an integrated circuit chip or module that can be plugged or installed into a communication device as described with respect to FIG. 5. In such cases, the apparatus 610 may be implemented as a communication device as described with respect to FIG. 5.

In some implementations, the one or more memories 612 and the computer program codes 613 may be configured to, with the one or more processors 611, cause the apparatus 610 at least to perform any operation of the method as described in connection with FIG. 5. Alternatively or additionally, the one or more memories 612 and the computer program codes 613 may be configured to, with the one or more processors 611, cause the apparatus 610 at least to perform more or less operations to implement the proposed methods according to the exemplary embodiments of the present disclosure.

FIG. 6B is a block diagram illustrating an apparatus 620 according to some embodiments of the present disclosure. As shown in FIG. 6B, the apparatus 620 may comprise an estimating unit 621 and a selecting unit 622. In an exemplary embodiment, the apparatus 620 may be implemented in a communication device. The estimating unit 621 may be operable to carry out the operation in block 502, and the selecting unit 622 may be operable to carry out the operation in block 504. Optionally, the estimating unit 621 and/or the selecting unit 622 may be operable to carry out more or less operations to implement the proposed methods according to the exemplary embodiments of the present disclosure.

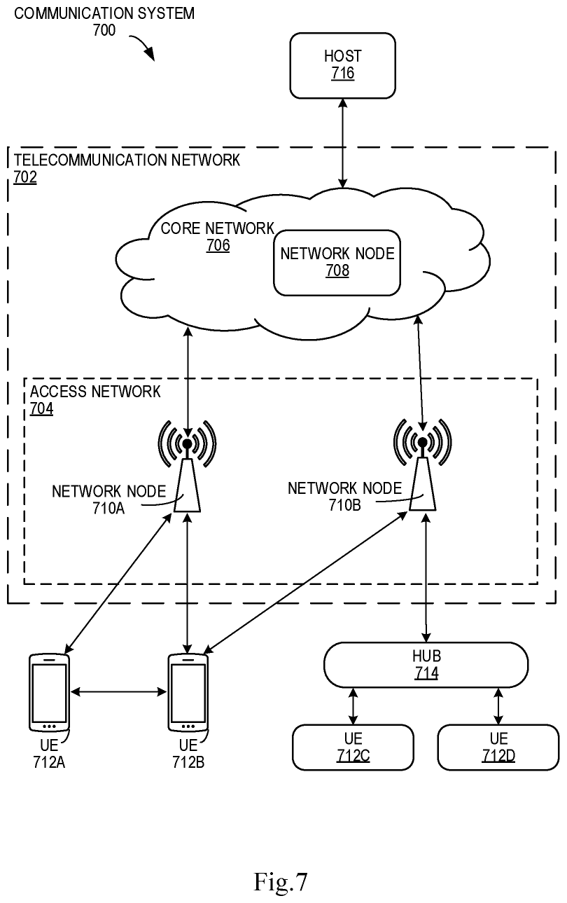

FIG. 7 shows an example of a communication system 700 in accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710A and 710B (one or more of which may be generally referred to as network nodes 710), or any other similar 3rd Generation Partnership Project (3GPP) access node or non-3GPP access point. The network nodes 710 facilitate direct or indirect connection of user equipment (UE), such as by connecting UEs 712A, 712B, 712C, and 712D (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712C and/or 712D) and network nodes (e.g., network node 710B). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710B. The hub 714 may also allow for a different communication scheme and/or schedule between the hub 714 and UEs (e.g., UE 712C and/or 712D), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710B. In other embodiments, the hub 714 may be a non-dedicated hub—that is, a device which is capable of operating to route communications between the UEs and network node 710B, but which is additionally capable of operating as a communication start and/or end point for certain data channels.

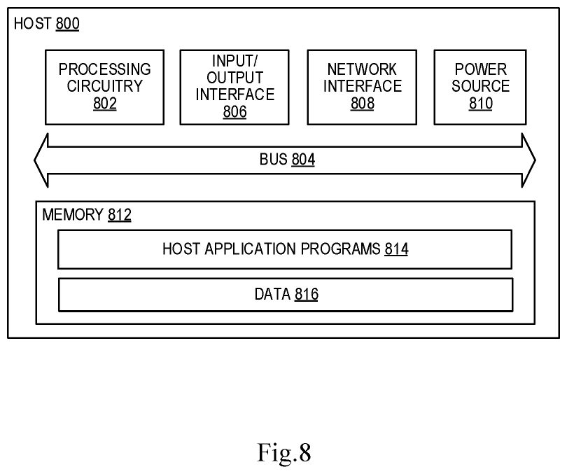

FIG. 8 is a block diagram of a host 800, which may be an embodiment of the host 716 of FIG. 7, in accordance with various aspects described herein. As used herein, the host 800 may be or comprise various combinations hardware and/or software, including a standalone server, a blade server, a cloud-implemented server, a distributed server, a virtual machine, container, or processing resources in a server farm. The host 800 may provide one or more services to one or more UEs.

The host 800 includes processing circuitry 802 that is operatively coupled via a bus 804 to an input/output interface 806, a network interface 808, a power source 810, and a memory 812. Other components may be included in other embodiments. Features of these components may be substantially similar to those described with respect to the devices of previous figures, such as FIG. 6A and FIG. 6B, such that the descriptions thereof are generally applicable to the corresponding components of host 800.

The memory 812 may include one or more computer programs including one or more host application programs 814 and data 816, which may include user data, e.g., data generated by a UE for the host 800 or data generated by the host 800 for a UE. Embodiments of the host 800 may utilize only a subset or all of the components shown. The host application programs 814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 814 may also provide for user authentication and licensing checks and may periodically report health, routes, and content availability to a central node, such as a device in or on the edge of a core network. Accordingly, the host 800 may select and/or indicate a different host for over-the-top services for a UE. The host application programs 814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

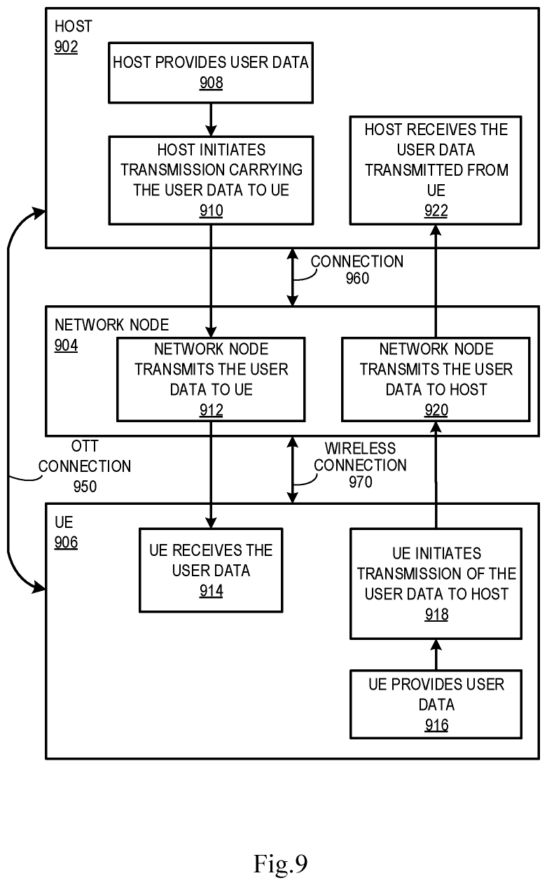

FIG. 9 shows a communication diagram of a host 902 communicating via a network node 904 with a UE 906 over a partially wireless connection in accordance with some embodiments. Example implementations, in accordance with various embodiments, of the UE (such as a UE 712A of FIG. 7), network node (such as network node 710A of FIG. 7), and host (such as host 716 of FIG. 7 and/or host 800 of FIG. 8) discussed in the preceding paragraphs will now be described with reference to FIG. 9.

Like host 800, embodiments of host 902 include hardware, such as a communication interface, processing circuitry, and memory. The host 902 also includes software, which is stored in or accessible by the host 902 and executable by the processing circuitry. The software includes a host application that may be operable to provide a service to a remote user, such as the UE 906 connecting via an over-the-top (OTT) connection 950 extending between the UE 906 and host 902. In providing the service to the remote user, a host application may provide user data which is transmitted using the OTT connection 950.

The network node 904 includes hardware enabling it to communicate with the host 902 and UE 906. The connection 960 may be direct or pass through a core network (like core network 706 of FIG. 7) and/or one or more other intermediate networks, such as one or more public, private, or hosted networks. For example, an intermediate network may be a backbone network or the Internet.

The UE 906 includes hardware and software, which is stored in or accessible by UE 906 and executable by the UE's processing circuitry. The software includes a client application, such as a web browser or operator-specific “app” that may be operable to provide a service to a human or non-human user via UE 906 with the support of the host 902. In the host 902, an executing host application may communicate with the executing client application via the OTT connection 950 terminating at the UE 906 and host 902. In providing the service to the user, the UE's client application may receive request data from the host's host application and provide user data in response to the request data. The OTT connection 950 may transfer both the request data and the user data. The UE's client application may interact with the user to generate the user data that it provides to the host application through the OTT connection 950.

The OTT connection 950 may extend via a connection 960 between the host 902 and the network node 904 and via a wireless connection 970 between the network node 904 and the UE 906 to provide the connection between the host 902 and the UE 906. The connection 960 and wireless connection 970, over which the OTT connection 950 may be provided, have been drawn abstractly to illustrate the communication between the host 902 and the UE 906 via the network node 904, without explicit reference to any intermediary devices and the precise routing of messages via these devices.

As an example of transmitting data via the OTT connection 950, in step 908, the host 902 provides user data, which may be performed by executing a host application. In some embodiments, the user data is associated with a particular human user interacting with the UE 906. In other embodiments, the user data is associated with a UE 906 that shares data with the host 902 without explicit human interaction. In step 910, the host 902 initiates a transmission carrying the user data towards the UE 906. The host 902 may initiate the transmission responsive to a request transmitted by the UE 906. The request may be caused by human interaction with the UE 906 or by operation of the client application executing on the UE 906. The transmission may pass via the network node 904, in accordance with the teachings of the embodiments described throughout this disclosure. Accordingly, in step 912, the network node 904 transmits to the UE 906 the user data that was carried in the transmission that the host 902 initiated, in accordance with the teachings of the embodiments described throughout this disclosure. In step 914, the UE 906 receives the user data carried in the transmission, which may be performed by a client application executed on the UE 906 associated with the host application executed by the host 902.

In some examples, the UE 906 executes a client application which provides user data to the host 902. The user data may be provided in reaction or response to the data received from the host 902. Accordingly, in step 916, the UE 906 may provide user data, which may be performed by executing the client application. In providing the user data, the client application may further consider user input received from the user via an input/output interface of the UE 906. Regardless of the specific manner in which the user data was provided, the UE 906 initiates, in step 918, transmission of the user data towards the host 902 via the network node 904. In step 920, in accordance with the teachings of the embodiments described throughout this disclosure, the network node 904 receives user data from the UE 906 and initiates transmission of the received user data towards the host 902. In step 922, the host 902 receives the user data carried in the transmission initiated by the UE 906.

One or more of the various embodiments improve the performance of OTT services provided to the UE 906 using the OTT connection 950, in which the wireless connection 970 forms the last segment. More precisely, the teachings of these embodiments may improve the traffic performance such as data rate, latency and power consumption, and thereby provide benefits such as lower complexity, reduced user waiting time, relaxed restriction on file size, improved content resolution, better responsiveness, extended battery lifetime, etc.

In an example scenario, factory status information may be collected and analyzed by the host 902. As another example, the host 902 may process audio and video data which may have been retrieved from a UE for use in creating maps. As another example, the host 902 may collect and analyze real-time data to assist in controlling vehicle congestion (e.g., controlling traffic lights). As another example, the host 902 may store surveillance video uploaded by a UE. As another example, the host 902 may store or control access to media content such as video, audio, VR or AR which it can broadcast, multicast or unicast to UEs. As other examples, the host 902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 950 between the host 902 and UE 906, in response to variations in the measurement results. The measurement procedure and/or the network functionality for reconfiguring the OTT connection may be implemented in software and hardware of the host 902 and/or UE 906. In some embodiments, sensors (not shown) may be deployed in or in association with other devices through which the OTT connection 950 passes; the sensors may participate in the measurement procedure by supplying values of the monitored quantities exemplified above, or supplying values of other physical quantities from which software may compute or estimate the monitored quantities. The reconfiguring of the OTT connection 950 may include message format, retransmission settings, preferred routing etc.; the reconfiguring need not directly alter the operation of the network node 904. Such procedures and functionalities may be known and practiced in the art. In certain embodiments, measurements may involve proprietary UE signaling that facilitates measurements of throughput, propagation times, latency and the like, by the host 902. The measurements may be implemented in that software causes messages to be transmitted, in particular empty or ‘dummy’ messages, using the OTT connection 950 while monitoring propagation times, errors, etc.

According to some exemplary embodiments, there is provided a host configured to operate in a communication system to provide an over-the-top (OTT) service. The host may comprise: processing circuitry configured to provide user data; and a network interface configured to initiate transmission of the user data to a network node in a cellular network for transmission to a user equipment (UE). The network node may have a communication interface and processing circuitry, and the processing circuitry of the network node may be configured to perform operations of the exemplary method 500 as described with respect to FIG. 5 to transmit the user data from the host to the UE. In an embodiment, the processing circuitry of the host may be configured to execute a host application that provides the user data, and the UE may comprise processing circuitry configured to execute a client application associated with the host application to receive the transmission of user data from the host.

According to some exemplary embodiments, there is provided a method implemented in a host configured to operate in a communication system that further includes a network node and a user equipment (UE). The method may comprise: providing user data for the UE; and initiating a transmission carrying the user data to the UE via a cellular network comprising the network node. The network node may perform operations of the exemplary method 500 as described with respect to FIG. 5 to transmit the user data from the host to the UE. In an embodiment, the method may further comprise: at the network node, transmitting the user data provided by the host for the UE. In another embodiment, the user data may be provided at the host by executing a host application that interacts with a client application executing on the UE, the client application being associated with the host application.

According to some exemplary embodiments, there is provided a communication system configured to provide an over-the-top service. The communication system may comprise a host comprising: processing circuitry configured to provide user data for a user equipment (UE), the user data being associated with the over-the-top service; and a network interface configured to initiate transmission of the user data toward a cellular network node for transmission to the UE. The network node may have a communication interface and processing circuitry, and the processing circuitry of the network node may be configured to perform operations of the exemplary method 500 as described with respect to FIG. 5 to transmit the user data from the host to the UE. In an embodiment, the communication system may further comprise the network node and/or the user equipment. In another embodiment, the processing circuitry of the host may be configured to execute a host application, thereby providing the user data; and the host application may be configured to interact with a client application executing on the UE, the client application being associated with the host application.

According to some exemplary embodiments, there is provided a host configured to operate in a communication system to provide an over-the-top (OTT) service. The host may comprise: processing circuitry configured to initiate receipt of user data; and a network interface configured to receive the user data from a network node in a cellular network. The network node may have a communication interface and processing circuitry, and the processing circuitry of the network node may be configured to perform operations of the exemplary method 500 as described with respect to FIG. 5 to receive the user data from the UE for the host. In an embodiment, the processing circuitry of the host may be configured to execute a host application, thereby providing the user data; and the host application may be configured to interact with a client application executing on the UE, the client application being associated with the host application. In another embodiment, the initiating receipt of the user data may comprise requesting the user data.

According to some exemplary embodiments, there is provided a method implemented by a host configured to operate in a communication system that further includes a network node and a user equipment (UE). The method may comprise: at the host, initiating receipt of user data from the UE, the user data originating from a transmission which the network node has received from the UE. The network node may perform operations of the exemplary method 500 as described with respect to FIG. 5 to receive the user data from the UE for the host. In an embodiment, the method may further comprise: at the network node, transmitting the received user data to the host.

According to some exemplary embodiments, there is provided a host configured to operate in a communication system to provide an over-the-top (OTT) service. The host may comprise: processing circuitry configured to provide user data; and a network interface configured to initiate transmission of the user data to a cellular network for transmission to a user equipment (UE). The UE may comprise a communication interface and processing circuitry, and the communication interface and processing circuitry of the UE may be configured to perform operations of the exemplary method 500 as described with respect to FIG. 5 to receive the user data from the host. In an embodiment, the cellular network may further include a network node configured to communicate with the UE to transmit the user data to the UE from the host. In another embodiment, the processing circuitry of the host may be configured to execute a host application, thereby providing the user data; and the host application may be configured to interact with a client application executing on the UE, the client application being associated with the host application.

According to some exemplary embodiments, there is provided a method implemented by a host operating in a communication system that further includes a network node and a user equipment (UE). The method may comprise: providing user data for the UE; and initiating a transmission carrying the user data to the UE via a cellular network comprising the network node. The UE may perform operations of the exemplary method 500 as described with respect to FIG. 5 to receive the user data from the host. In an embodiment, the method may further comprise: at the host, executing a host application associated with a client application executing on the UE to receive the user data from the UE. In another embodiment, the method may further comprise: at the host, transmitting input data to the client application executing on the UE, the input data being provided by executing the host application. The user data may be provided by the client application in response to the input data from the host application.

According to some exemplary embodiments, there is provided a host configured to operate in a communication system to provide an over-the-top (OTT) service. The host may comprise: processing circuitry configured to utilize user data; and a network interface configured to receipt of transmission of the user data to a cellular network for transmission to a user equipment (UE). The UE may comprise a communication interface and processing circuitry, and the communication interface and processing circuitry of the UE may be configured to perform operations of the exemplary method 500 as described with respect to FIG. 5 to transmit the user data to the host. In an embodiment, the cellular network may further include a network node configured to communicate with the UE to transmit the user data from the UE to the host. In another embodiment, the processing circuitry of the host may be configured to execute a host application, thereby providing the user data, and the host application may be configured to interact with a client application executing on the UE, the client application being associated with the host application.

According to some exemplary embodiments, there is provided a method implemented by a host configured to operate in a communication system that further includes a network node and a user equipment (UE). The method may comprise: at the host, receiving user data transmitted to the host via the network node by the UE. The UE may perform operations of the exemplary method 500 as described with respect to FIG. 5 to transmit the user data to the host. In an embodiment, the method may further comprise: at the host, executing a host application associated with a client application executing on the UE to receive the user data from the UE. In another embodiment, the method may further comprise: at the host, transmitting input data to the client application executing on the UE, the input data being provided by executing the host application. The user data may be provided by the client application in response to the input data from the host application.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed by a communication device, comprising:
estimating slot-based channel temporal auto-correlation according to a set of channel estimates of reference signals; and
selecting a precoder for a first slot from a set of precoder candidates according to the slot-based channel temporal auto-correlation, wherein the set of precoder candidates is calculated by using at least part of the set of the channel estimates of the reference signals.

2. The method according to claim 1, wherein estimating the slot-based channel temporal auto-correlation according to the set of the channel estimates of the reference signals comprises:
obtaining reference signal period-based channel temporal auto-correlation according to the set of the channel estimates of the reference signals; and
estimating the slot-based channel temporal auto-correlation according to the reference signal period-based channel temporal auto-correlation.

3. The method according to claim 2, wherein the slot-based channel temporal auto-correlation is estimated according to interpolation of the reference signal period-based channel temporal auto-correlation.

4. The method according to claim 2, wherein the reference signal period-based channel temporal auto-correlation is obtained according to non-coherent combined calculation on the set of the channel estimates of the reference signals.

5. The method according to claim 1, wherein estimating the slot-based channel temporal auto-correlation according to the set of the channel estimates of the reference signals comprises:
obtaining slot-based channel estimation according to the set of the channel estimates of the reference signals; and
estimating the slot-based channel temporal auto-correlation according to the slot-based channel estimation.

6. The method according to claim 5, wherein the slot-based channel estimation is obtained according to interpolation of the set of the channel estimates of the reference signals.

7. The method according to claim 5, wherein the slot-based channel temporal auto-correlation is estimated according to non-coherent combined calculation on the slot-based channel estimation.

8. The method according to claim 1, wherein the precoder selected for the first slot from the set of precoder candidates is a first precoder candidate which is calculated by using a channel estimate of a second slot, and wherein according to the slot-based channel temporal auto-correlation, the second slot, among slots in which reference signals are received by the communication device, has strongest channel temporal correlation with the first slot.

9. The method according to claim 1, wherein the precoder selected for the first slot from the set of precoder candidates is a second precoder candidate which is calculated by using a channel estimate of a third slot, and wherein the third slot, among slots in which reference signals are received by the communication device, is a second closest slot to the first slot.

10. The method according to claim 1, wherein when a time interval between the first slot and a fourth slot is within a predetermined range, the precoder selected for the first slot from the set of precoder candidates is a precoder candidate associated with the predetermined range, and wherein the fourth slot, among slots in which reference signals are received by the communication device, is a slot closest to the first slot.

11. The method according to claim 10, wherein the predetermined range is a first range, and the precoder candidate associated with the predetermined range is a third precoder candidate which is calculated by using a channel estimate of the fourth slot.

12. The method according to claim 10, wherein the predetermined range is a second range, and the precoder candidate associated with the predetermined range is a fourth precoder candidate which is calculated by using a channel estimate of a fifth slot, and wherein the fifth slot, among the slots in which the reference signals are received by the communication device, is a second closest slot to the first slot.

13. The method according to claim 10, wherein the predetermined range is a third range, and the precoder candidate associated with the predetermined range is a fifth precoder candidate which is calculated by using a channel estimate of a sixth slot, and wherein the sixth slot, among the slots in which the reference signals are received by the communication device, is a third closest slot to the first slot.

14. The method according to claim 10, wherein the predetermined range is based at least in part on one or more of:
the slot-based channel temporal auto-correlation;
throughput related to the slot-based channel temporal auto-correlation;
average channel temporal correlation which is calculated according to the slot-based channel temporal auto-correlation; and
reference signal channel estimation processing delay.

15. The method according to claim 14, wherein the calculation of the average channel temporal correlation is based at least in part on slots to be scheduled for the communication device.

16. A communication device, comprising:
one or more processors; and
one or more memories comprising computer program codes,
the one or more memories and the computer program codes configured to, with the one or more processors, cause the communication device at least to:
estimate slot-based channel temporal auto-correlation according to a set of channel estimates of reference signals; and
select a precoder for a first slot from a set of precoder candidates according to the slot-based channel temporal auto-correlation, wherein the set of precoder candidates is calculated by using at least part of the set of the channel estimates of the reference signals.

17-18. (canceled)

19. The method according to claim 3, wherein the reference signal period-based channel temporal auto-correlation is obtained according to non-coherent combined calculation on the set of the channel estimates of the reference signals.

20. The method according to claim 6, wherein the slot-based channel temporal auto-correlation is estimated according to non-coherent combined calculation on the slot-based channel estimation.
